(19) United States
(12) Patent Application Publication
(10) Pub. No.: US 2010/0129704 A1
(43) Pub. Date: May 27, 2010

(54) Silicon Negative Electrode, Lithium Ion Battery, Method of Preparing the Same

(75) Inventors: Xiaojun Luo, Shenzhen (CN); Guihai Liang, Shenzhen (CN)

Correspondence Address: BRINKS HOFER GILSON & LIONE, P.O. BOX 10395, CHICAGO, IL, 60610, US

(73) Assignee: BYD Co., Ltd., Shenzhen (CN)

(21) Appl. No.: 12/556,896

(22) Filed: Sep. 10, 2009

(30) Foreign Application Priority Data
Nov. 27, 2008 (CN) 200810217716.1

(51) Int. Cl. H01M 4/62; H01M 2/02; H01M 4/04

(52) U.S. Cl. 429/163; 429/217; 427/58

(57) ABSTRACT

A silicon negative electrode comprises a current collector coated with a negative electrode material. The negative electrode material comprises a silicon negative active material and a binder. The binder comprises a first polymer, a second polymer, and a third polymer. The first polymer comprises a fluorine-containing monomer. The second polymer comprises a monomer selected from the group consisting of acrylonitrile, methacrylonitrile, acrylates, methacrylates, and combinations thereof. The third polymer is selected from the group consisting of polyvinylpyrrolidone, polyalkylidene glycol, polyacrylamide, polyethylene glycol, and combinations thereof.

### CROSS-REFERENCE TO RELATED APPLICATION

This application claims priority to Chinese Patent Application No. 200810217716.1, filed Nov. 27, 2008.

### TECHNICAL FIELD

The present disclosure relates to a silicon negative electrode, a lithium battery, and a method for preparing the same.

### BACKGROUND

Lithium ion batteries usually have a small volume and a high energy density. They have been widely used in mobile communication devices, digital cameras and laptops. At present, the capacity of lithium ion batteries employing conventional LiCoO/graphite system has almost reached the maximum theoretical capacity. It may be difficult to increase the volume energy density by further improving properties of electrode materials, or decreasing the volume of current collectors and separators. With the development of mobile electronic devices, it may be desirable to have a high-capacity battery.

In recent years, applications of silicon-based materials in the negative electrode have been widely studied. The Si-based material has both crystal and amorphous forms. The amorphous Si-based material is more suitable for negative electrodes. Furthermore, microcrystal silicon materials can also be used as negative materials. The microcrystal form is a form between the crystal and the amorphous forms. During the charge and discharge processes, lithium ions may be intercalated and de-intercalated with Si-based materials. When lithium ions are intercalated with Si materials, they may form an alloy with the silicon materials, which may provide a high specific capacity for batteries. The theoretical capacity may reach about 4200 mAh/g.

However, the volume of the Si-based material may change with the intercalation and de-intercalation of lithium ions. For example, the volume of the Si-based material may expand about 4 times of the original size after the intercalation of lithium ions. The volume change may cause a series of problems. For example, the negative electrode material may be crushed and powered during the charge and discharge cycling. Lithium ions may lose the ability to intercalate and de-intercalate. The performance of the battery may decrease because of the flaking of the negative materials, wrinkling of current collectors, and bulging deformation of battery cores.

As an important part of the negative electrode material, a binder is used to hold the material particles together and also attach the particles onto the current collector. The binder also prevents negative active materials from crushing and powdering. Therefore, it determines the performance of the electrode to a great extent. At present, the common electrode binders are styrene-butadiene rubber (SBR) and fluorine-containing polymers without functional groups.

For example, polyvinylidene fluoride (PVDF) has been used in negative electrodes. PVDF has a strong binding force. However, PVDF may swell in most organic electrolytes, such as propylene carbonate, dimethoxy ethane and y-butyrolactone. After swelling, the binding force of the binder may decrease and the microstructure of electrode materials may not be recovered. Thus it may have a negative effect on the battery performance.

Another commonly used binder, SBR, has a good elasticity. However, it has a relatively weak binding force. The binding may not be stable between the particles and between the particles and the current collectors. The electrode performance of the negative electrode may be low. For the Si negative electrode that has a high volumetric expansion, SBR may not meet the requirements. Therefore, it would be desirable to develop an improved binder in order to improve the performance of batteries.

### SUMMARY

In one aspect, a silicon negative electrode comprises a current collector coated with a negative electrode material. The negative electrode material comprises a silicon negative active material and a binder. The binder comprises a first polymer, a second polymer, and a third polymer. The first polymer comprises a fluorine-containing monomer. The second polymer comprises a monomer selected from the group consisting of acrylonitrile, methacrylonitrile, acrylates, methacrylates, and combinations thereof. The third polymer is selected from the group consisting of polyvinylpyrrolidone, polyalkylidene glycol, polyacrylamide, polyethylene glycol, and combinations thereof.

In another aspect, a lithium battery comprises: a negative electrode; a positive electrode; a non-aqueous electrolyte in contact with the negative electrode and the positive electrode; a separator disposed between the negative electrode and the positive electrode; and a shell. The negative electrode, the positive electrode, the separator and the electrolyte are disposed in the shell. The shell is sealed. The silicon negative electrode comprises a current collector coated with a negative electrode material. The negative electrode material comprises a silicon negative active material and a binder. The binder comprises a first polymer, a second polymer, and a third polymer. The first polymer comprises a fluorine-containing monomer. The second polymer comprises a monomer selected from the group consisting of acrylonitrile, methacrylonitrile, acrylates, methacrylates, and combinations thereof. The third polymer is selected from the group consisting of polyvinylpyrrolidone, polyalkylidene glycol, polyacrylamide, polyethylene glycol, and combinations thereof.

In yet another aspect, a method for preparing a negative electrode comprises coating a negative electrode material onto a negative current collector. The negative electrode material comprises a silicon negative active material and a binder. The binder comprises a first polymer, a second polymer, and a third polymer. The first polymer comprises a fluorine-containing monomer. The second polymer comprises a monomer selected from the group consisting of acrylonitrile, methacrylonitrile, acrylates, methacrylates, and combinations thereof. The third polymer is selected from the group consisting of polyvinylpyrrolidone, polyalkylidene glycol, polyacrylamide, polyethylene glycol, and combinations thereof.

### DETAILED DESCRIPTION OF THE PREFERRED EMBODIMENTS

The present disclosure provides a silicon negative electrode. The silicon negative electrode comprises a current collector coated with a negative electrode material. The negative electrode material comprises a silicon negative active material and a binder. The binder comprises a first polymer, a second polymer, and a third polymer. The first polymer comprises a fluorine-containing monomer. The second polymer comprises a monomer selected from the group consisting of acrylonitrile, methacrylonitrile, acrylates, methacrylates, and combinations thereof. The third polymer is selected from the group consisting of polyvinylpyrrolidone, polyalkylidene glycol, polyacrylamide, polyethylene glycol, and combinations thereof.

The first polymer can be any suitable fluorine-containing polymer. The polymer comprises a fluorine-containing monomer. The fluorine-containing monomer can be selected from the group consisting of vinylidene fluoride, fluoroethylene, trifluoroethylene, tetrafluoroethylene, pentafluoroethylene, hexafluoroethylene, and combinations thereof. Preferably, the fluorine-containing polymer is selected from the group consisting of polyvinylidene fluoride, polytetrafluoroethylene, polyhexafluoropropylene, a copolymer of vinylidene fluoride and hexafluoropropylene, and combinations thereof.

Preferably, the number average molecular weight of the fluorine-containing polymer is in a range of between about 1×10⁵ and about 1×10⁷. More preferably, it is in a range of between about 2×10⁵ and about 7×10⁶. In this molecular weight range, the binder may not swell easily. The binding force may be enhanced during the cycling process, and the flaking of the electrode material may be avoided too. Thus, the cycling performance may be improved.

The first polymer can further comprise a functional group. The term “functional group” means any group defined as functional groups in chemistry, such as groups containing halogens, oxygen, nitrogen, phosphorus, or sulfur. The functional group in the present disclosure is preferred to be carboxyl or carbonyl group. The carbonyl and carboxyl groups can form a hydrogen bonding with the O—H group in the solution, which would increase the elasticity of the film and may avoid the flaking of the negative electrode material and improve the cycling performance of the Si negative electrode. The carboxyl and carbonyl groups can be unsaturated monocarboxylic acids, unsaturated dicarboxylic acids, monoalkyl esters of the unsaturated dicarboxylic acids, unsaturated aldehydes, unsaturated ketones, or unsaturated monocarboxylic esters. The unsaturated monocarboxylic acids include but not limit to acrylic acid and methacrylic acid. The unsaturated dicarboxylic acids comprise but not limit to maleic acid and citraconic acid. The mono-alkyl esters of the unsaturated dicarboxylic acids comprise but not limit to monomethyl maleate, monoethyl maleate, monomethyl citraconic ester, and monoethyl citraconic ester. Preferably, the monomer with a carbonyl group is selected from the group consisting of unsaturated aldehydes, unsaturated ketones, unsaturated monocarboxylic esters, and combinations thereof.

Preferably, the first polymer comprises a functional group-containing monomer and a fluorine-containing monomer. Preferably, the weight ratio of the functional group-containing monomer and the fluorine-containing monomer is in a range of between about 1:10 and about 1:1000. More preferably, the ratio is in a range of between about 1:20 and about 1:500. The polymer can be obtained by regular copolymerization methods. Preferably, the copolymer has a number average molecular weight in a range of between about 1×10⁴ and about 1×10⁷. More preferably, the molecular weight is in a range of between about 2×10⁴ and about 6×10⁶.

Preferably, the first polymer is polyvinylidene fluoride with carboxyl or carbonyl groups. It can be prepared by conventional copolymerization of the monomers with carboxyl or carbonyl groups and the vinylidene fluoride. Commercially available products can also used. For example, Kureha Corporation provides kinds of fluorine-containing polymers with functional groups that can be used as a first polymer.

The second polymer can be any suitable polymer. For example, the monomer can be selected from the group consisting of acrylonitrile, methacrylonitrile, acrylates, methacrylates, and combinations thereof. Preferably, the second polymer is selected from the group consisting of polyacrylonitrile, polymethacrylonitrile, polyacrylate, polymethacrylate, and combinations thereof. The acrylate monomers can include but not limit to methyl acrylate, ethyl acrylate, propyl acrylate, butyl acrylate, pentyl acrylate, dodecyl acrylate, and the isomers thereof. The methacrylate monomers can be but not limit to methyl methacrylate, ethyl methacrylate, propyl methacrylate, butyl methacrylate, pentyl methacrylate, dodecyl methacrylate, and the isomers thereof.

Preferably, the second polymer is selected from the group consisting of polyacrylonitrile, polymethacrylonitrile, polymethacrylate, and combinations thereof. These polymers may increase the interactions between the negative active materials and improve the performance of the Si negative electrode. Preferably, the number average molecular weight is in a range of between about 1×10³ and about 1×10⁶. More preferably, it is in a range of between about 3×10³ and about 5×10⁵.

The third polymer can be any suitable material. Preferably, the third polymer is selected from the group consisting of polyvinylpyrrolidone (PVP), polyglycol (PEG), poly(alkylidene)glycol, polyacrylamide, and combinations thereof.

Preferably, the third polymer has a number average molecular weight in a range of between about 500 and about 1×10⁷. The third polymer in the present disclosure has a binding force higher than 25 g/cm and may improve the binding force of the silicon negative electrode.

Preferably, the weight percentage of the first polymer is about 1-90% of the total weight of the binder. More preferably, it is about 30%-60%. The weight percentage of the second polymer is about 1-60% of the total weight of the binder. More preferably, it is about 30%-60%. The weight percentage of the third polymer is about 0.001-50% of the total weight of the binder. More preferably, it is about 10%-30%.

The binder in the present disclosure is a combination of three polymers and has a relatively high binding force. A small amount of the binder would hold negative material particles together and increase the adhesive force of the negative materials to the current collector. Thus it may help to increase the specific capacity of the battery and rate charge and discharge performance. Meanwhile, the binder in the present disclosure would not swell or only swell slightly in the electrolyte. The electrode material may not flake in the cycling processes. The high binding force may be maintained and the cycling performance of the lithium ion battery may be enhanced. Furthermore, the binder in the present disclosure may enhance the porosity of the Si-based materials and improve the microstructure of the materials. High porosity may decrease volume expansion caused by the intercalation and de-intercalation of lithium ions. Thus the cycling performance of the lithium ion batteries may be enhanced. Also the binder may strengthen the interactions between the material particles. Thus, electrodes may have good mechanical properties. The ion transfer may be facilitated in the material and the conductivity of the electrode may be enhanced. Therefore, the discharging performance of the battery may be enhanced.

Preferably, the binder is distributed into a dispersant. The dispersant can be any suitable reagent, such as organic solvents. For example, the dispersant is selected from the group consisting of N-methyl-2-pyrrolidone(NMP), propylene carbonate(PC), ethylene carbonate(EC), di-methoxy ethane(DME), dioxolane(DO), tetrahydrofuran(THF), acetonitrile(CH₃CN), diethyl carbonate(DEC), dimethyl carbonate(DMC), ethyl methyl carbonate(EMC), dimethyl sulfoxide(DMSO), methyl acetate(MA), methyl formate (MF), sulfolane, and combinations thereof. The first polymer, the second polymer, and the third polymer can be added into the dispersant in any order. In the present disclosure, the silicon negative electrode material can be prepared by adding a Si negative active material, a conductive agent, an additive into the mixture of the binder and the dispersant. The mixture should be sticky and can be coated onto a current collector. Commonly, based on 100 parts by weight of the silicon negative active material, the dispersant is about 100-173 parts by weight. Preferably, it is about 127-173 parts by weight.

In the silicon negative electrode provided in the present disclosure, based on 100 parts by weight of the Si negative electrode material, preferably, the binder is about 8-12.5 parts by weight. More preferably, it is about 10-12 parts by weight.

The Si negative electrode active material in the present disclosure is preferably to be a composite of a metal and a silicon material. For example, it can be Si—Ti—Cu with a weight ratio of about 1:1:1. It can also be Si—Cu with a weight ratio of about 1:2.

The Si negative electrode material may optionally comprise a conductive agent. The conductive agent is selected from the group consisting of graphite, carbon black, acetylene black, colloidal carbon, carbon fiber, and combinations thereof. Based on 100 parts by weight of the Si negative active material, the conductive agent can be about 0.01-5 parts by weight. Preferably, it is about 1-5 parts by weight. More preferably, it is about 3-5 parts by weight.

The current collector in the present disclosure can be any conventional negative current collector used in the lithium ion batteries. In the preferred embodiments of the present disclosure, Cu foil is a preferred current collector.

A method for preparing a negative electrode is provided. The method comprises coating a negative electrode material onto a negative current collector. The negative electrode material comprises a silicon negative active material and a binder. The binder comprises a first polymer, a second polymer, and a third polymer. The first polymer comprises a fluorine-containing monomer. The second polymer comprises a monomer selected from the group consisting of acrylonitrile, methacrylonitrile, acrylates, methacrylates, and combinations thereof. The third polymer is selected from the group consisting of polyvinylpyrrolidone, poly(alkylidene) glycol, acrylamide, polyethylene glycol, and combinations thereof.

The method can further comprise forming a coating material. For example, a Si based active material, a binder, acetylene black, and a solvent can be mixed to provide a coating material. The method can also comprise drying and pressing the coated collector. The method for drying and pressing is known to those skilled in the art.

In the present disclosure, a lithium ion battery is provided. The battery comprises a shell, a negative electrode, a positive electrode, a separator, and a non-aqueous electrolyte. The electrolyte is in contact with the negative electrode and the positive electrode. The separator is disposed between the negative electrode and the positive electrode. The negative electrode, the positive electrode, the separator, and the electrolyte are disposed in the shell. The shell is sealed. The negative electrode comprises a current collector coated with a silicon negative electrode material. The negative electrode material comprises a silicon negative active material and a binder. The binder comprises a first polymer, a second polymer, and a third polymer. The first polymer comprises a fluorine-containing monomer. The second polymer comprises a monomer selected from the group consisting of acrylonitrile, methacrylonitrile, acrylates, methacrylates, and combinations thereof. The third polymer is selected from the group consisting of polyvinylpyrrolidone, polyalkylidene glycol, acrylamide, polyethylene glycol, and combinations thereof.

Conventional positive electrodes, separators and non aqueous electrolytes can be used in the present disclosure. For example, the separator can be a microporous polyolefin film. The positive electrode can be prepared according to traditional methods. The composition of the positive material is known in the art. For example, the positive electrode comprises a current collector coated with a positive electrode material. Commonly, the positive material comprises a positive active material, a conductive agent and a binder. The positive active material can be any suitable positive material known in the art. For example, it can be selected from the group consisting of LiCoO₂, LiNiO₂, LiFeO₂, LiMn₂O₄, and combinations thereof. In the present disclosure, the preferred positive electrode material has a formula of LiₓFe_{y}M_{1-y}PO₄, 0.01≦x≦1.5, 0<y≦1. M is one member selected from B, Al, Mg, Ga, and the transition metal elements. Another example of the positive electrode material has a formula of Li₁₊ₓNi_{1-y-z}Mn_{y}Co_{z}LO₂, −0.1≦x≦0.2, 0≦y≦1, 0≦z≦1, 0≦y+z≦1.0. L is at least one member selected from B, Al, Mg, Ga and the transition metal elements. The binder can be any conventional binder used in the positive electrode of the lithium ion batteries. For example, it is selected from the group consisting of polyvinylidene fluoride(PVDF), polytetrafluoroethylene(PTFE), polyvinylchloride(PVC), styrene-butadiene rubber(SBR), latex of styrene-butadiene rubber (SBR), and combinations thereof. Based on 100 parts of the positive active material by weight, the binder is preferably to be about 2-10 parts by weight. More preferably, it is about 2-8 parts by weight. The conductive agent can be any conventional positive conductive agent. For example, it is selected from the group consisting of acetylene black, conductive carbon black, conductive graphite, and combinations thereof. Based on 100 parts of positive electrode active material by weight, the conductive agent is preferred to be 1-15 parts by weight. More preferably, it is about 2-10 parts by weight. The method for preparing the positive electrode can be any conventional method known to the art. The current collector of the positive electrode can by any traditional positive current collector in the lithium ion batteries. In the preferred embodiment of the present disclosure, Al foil is used as the positive electrode current collector.

The non aqueous electrolyte can be any traditional non aqueous electrolyte known in the art. Typically, it is a solution of lithium salt in a non aqueous solvent. The lithium electrolyte salt can be selected from the group consisting of LiPF₆, LiAsF₆, LiSbF₆, LiClO₄, LiBF₄, LiB₁₀Cl₁₀, LiAlCl₄, LiB(C₂H₅)₄, LiCF₃CO₂, LiCF₃SO₃, LiCH₃SO₃, LiC₄F₉S₃, Li(CF₃SO₃)₂N, lithium halides, short chain alkyl fatty acid lithium salts, and combinations thereof. The non aqueous solvent can be a mixed solution of a short-chain alky ester and other solvents. The short chain alky ester can be selected from the group consisting of dimethyl carbonate(DMC), diethyl carbonate(DEC), ethyl methyl carbonate(EMC), methyl propyl carbonate(MPC), dipropyl carbonate(DPC), fluorine-containing esters, sulfur-containing esters, unsaturated esters, and combinations thereof. The other solvent can be at least one selected from ethylene carbonate (EC), propylene carbonate (PC), vinyl carbonate (VC), γ-butyrolactone (γ-BL), sultone, fluorine-containing esters, sulfur-containing esters, and unsaturated cyclic esters. The amount of the electrolyte is 1.5-4.9 g/Ah. The concentration of lithium salt is about 0.5-2.9 mol/L.

The lithium ion batteries in the present disclosure can be prepared by conventional methods. Commonly, a separator is placed between the positive electrode and the negative electrode to form a cell core. The core is disposed in a battery shell. The electrolyte is injected into the shell. The shell is sealed to provide a lithium ion battery.

The aforementioned features and advantages of the invention as well as additional features and advantages thereof will be more clearly understood hereafter as a result of a detailed description of the following embodiments.

### Example 1

(1) Preparation of the Si Negative Active Electrode Material

Silicon powder (1-5 μm, 99.9%, CHINA KAIHUAYUANTONG SILICON INDUSTRY CO., LTD.), Ti powder (45 μm, 99%, CHINA SHENZHEN SHIHUA TECHNOLOGY CO., LTD.), and Cu powder (45 um, 99.9%, BEIJING HAOYUN INDUSTRY CO., LTD.) were mixed at a weight ratio of about 1:1:1. Then the mixture was ball milled in a planetary ball milling machine (model QM-3SP4J) at a speed of about 300 r/min for about 24 hours. After the ball-milling, the mixture was sifted through a 400-mesh screen to provide a silicon negative active electrode material.

The obtained sample was tested on an XRD instrument of model D/MAX2200PC in the Rigaku Corporation. Cu₃Si, Si, Ti and Cu were found.

(2) Preparation of Si Negative Electrode

6.7 g of a second polymer PAN (Shangyu Wuyue trade Co., Ltd. The molecular weight is 50,000) was dissolved into 221 g of NMP to provide a solution. Then 6.7 g of a first polymer PVDF (Shanghai Aifu New Material Co., Ltd, 7200#) and 4.3 g of a third polymer PVP (Sinopharm Chemical Reagent Co., Ltd, the molecular weight is 30,000) was dissolved into the above mentioned binder solution in sequence to provide a binder solution. The weight ratio of the binder was about 7% in the solution.

The Si negative active electrode material was added into the binder solution at a weight ratio of about 9:1 to provide a mixture. The mixture was stirred in a vacuum mixer to form a stable and uniform slurry. The slurry was then coated on a Cu foil uniformly. A pressure of about 2 MP was applied onto the coated foil. Then the coated foil was treated at a temperature of about 300° C. in nitrogen for about 24 hours. The foil was pressed and cut into negative plates in a size of about 416 mm×45 mm. Each of the negative plate comprised around 2.8 g of negative active materials.

(3) Preparation of Batteries

90 g polyvinylidene fluoride (ATOFINA co., 761# PVDF) was dissolved in 1350 g N-methyl-2-pyrrolidone to provide a binder solution. Then to the solution was added 2895 g LiCoO₂ (FMC company's product). The solution was mixed sufficiently to provide a positive slurry. The positive slurry was coated uniformly onto an aluminum foil and dried for about 1 hour under 125° C. Then the coated foil was pressed and cut into positive electrode plates of a size of about 424×44 mm. Each positive electrode plate comprised around 6.1 g of positive active materials.

The positive electrode plates, polypropylene separators with a thickness of 20 um, and the negative electrode plates were stacked in sequence to form a cell core. The cell core was disposed into a battery shell. An electrolyte was injected into the battery shell at an amount of 3.8 g/Ah. The shell was sealed to form a regular LP053450 battery. The battery electrolyte comprised Li PF₆ at a concentration of about 1 mol/L and a non aqueous solvent. The non aqueous solvent was a mixture of ethylene carbonate(EC) and diethyl carbonate(DEC) at a weight ratio of about 1:1.

### Example 2

The same preparation method was employed to prepare a Si negative electrode and a battery. The only difference was the first polymer in the binder was PTFE (Zhejiang Juhua Co., limited, the molecular weight is about 8×10⁵).

### Example 3

A Si negative electrode and a battery were prepared by the same method in example 1. The only difference was that the second polymer was ethylene-propylene copolymer (the molecular weight is about 200,000).

### Example 4

A Si negative electrode and a battery were prepared by the same method in example 1. The only difference was that the third polymer was PEG (the molecular weight is 200,000, Shanghai Sanpu Chemical co., LTD.).

### Example 5

A Si negative electrode and a battery were prepared by the same method in example 1. The difference was that the first polymer was PVDF (Shanghai Aifu New Material Co., Ltd, 7200#) and the amount was about 1.67 g. The amount of the second polymer PAN (Shangyu Wuyue trade Co., Ltd.) was about 0.5 g. The amount of the third polymer PVP (Sinopharm Chemical Reagent Co., Ltd) was about 0.4 g.

### Example 6

A Si negative electrode and a battery were prepared by the same method in example 1. The difference was that the first polymer was PVDF (Shanghai Aifu New Material Co., Ltd, 7200#) and the amount was about 1.67 g. The amount of the second polymer PAN (Shangyu Wuyue trade Co., Ltd.) was about 13.36 g. The amount of the third polymer PVP (Sinopharm Chemical Reagent Co., Ltd) was about 1.67 g.

Control 1

A Si negative electrode and a battery were prepared by the same method in example 1. The difference was that the binder comprised PVDF and PAN.

Control 2

A Si negative electrode and a battery were prepared by the same method in example 1. The difference was that the binder comprised PVDF, PAN and PI (polyimide) (Changzhou Guangchen new plastics co., Ltd).

Performance test:

1. Battery specific capacity test: the coated electrode plates were cut into round pieces with a diameter of about 15 mm. Lithium plates were used as counter electrodes to prepare CR2016 button batteries. The separator and the electrode were the same as example 1. The separator has a similar size to the negative electrode plate. The test was performed under room temperature and a humidity of about 25%-85%. The testing steps included: discharging the batteries step by step to simulate a constant voltage discharge. The detailed procedures were: stand by for about 60 min; discharge the battery at a constant current of about 0.2 mA to 0.2 V; discharge the battery at a constant current of about 1, 0.9, 0.8, 0.7, 0.6, 0.5, 0.4, and 0.05 mA successively, each time discharge the battery to 0.005 V, then cut off; stand by for about for 30 min; and charge the battery at a constant current of about 0.5 mA to 2.5 V. The result is shown in table 2.

2. Cycling performance test: the batteries prepared in examples 1-6 and controls 1-2 were charged at a current of about 80 mA (0.1 C) for about 960 minutes. The clamping voltage was about 4.2 V. After charging, the batteries stood by for about 15 min and then were discharged to about 3.0 V at a constant current of about 160 mA (0.2 C). The initial discharge capacity was tested using a secondary battery property testing equipment BS-9300R. The above mentioned charging and discharging steps were repeated for 50 times. After 50 cycles, the discharging capacities were measured. The discharging capacity retention rates were calculated according to the following formula: discharging capacity retention rate=discharging capacity after 50 cycles/initial discharge capacity×100%.

The result is shown as table 2.

3. Rate performance test: the test was performed under room temperature. The rate performance was evaluated by the ratio of the capacity at 0.5 C and the capacity at 1 C, and the ratio of the capacity at 1 C and the capacity at 0.2 C. The results are shown in table 2.

TABLE 1

| Binder | | | | | | | | |
|---|---|---|---|---|---|---|---|---|
| composition | Example 1 | Example 2 | Example 3 | Example 4 | Example 5 | Example 6 | Control 1 | Control 2 |
| First | PVDF | PTFE | PVDF | PVDF | PVDF | PVDF | PVDF | PVDF |
| polymer | 40% | 40% | 40% | 40% | 95% | 10% | 50% | 40% |
| Second | PAN | PAN | Ethylene | PAN | PAN | PAN | PAN | PAN |
| polymer | 40% | 40% | acrylic | 40% | 3% | 80% | 50% | 40% |
| | | | acid | | | | | |
| | | | copolymer | | | | | |
| | | | 40% | | | | | |
| Third | PVP | PVP | PVP | PEG | PVP | PVP | non | PI |
| polymer | 20% | 20% | 20% | 20% | 2% | 10% | | 20% |

TABLE 2

| Battery | | | | | | | | | |
|---|---|---|---|---|---|---|---|---|---|
| performance | | Example 1 | Example 2 | Example 3 | Example 4 | Example 5 | Example 6 | Control 1 | Control 2 |
| Specific | | 1100 | 1050 | 1060 | 1000 | 980 | 890 | 790 | 800 |
| capacity | | | | | | | | | |
| (mAh/g) | | | | | | | | | |
| Rate | 0.5 C/ | 99.7 | 98.9 | 98.6 | 98.1 | 98.5 | 97.6 | 95.3 | 95.5 |
| properties | 0.2 C | | | | | | | | |
| | 1 C/ | 98.9 | 98.2 | 97.9 | 97.2 | 97.4 | 95.8 | 94.2 | 94.6 |
| | 0.2 C | | | | | | | | |

| | | | | | | | | |
|---|---|---|---|---|---|---|---|---|
| Cycling | 89% | 87% | 88% | 85% | 82% | 80% | 75% | 73% |
| performance | | | | | | | | |

From the above tables we noted that the batteries using Si negative electrode in the present disclosure had relatively higher specific capacities and better rate discharging properties. The batteries also had better cycling properties and better performances.

Many modifications and other embodiments of the present disclosure will come to mind to one skilled in the art to which the present disclosure pertains having the benefit of the teachings presented in the foregoing description. It will be apparent to those skilled in the art that variations and modifications of the present disclosure can be made without departing from the scope or spirit of the present disclosure. Therefore, it is to be understood that the invention is not limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A silicon negative electrode comprising:
a current collector coated with a negative electrode material,
wherein the negative electrode material comprises a silicon negative active material and a binder;
wherein the binder comprises a first polymer, a second polymer, and a third polymer;
wherein the first polymer comprises a fluorine-containing monomer; the second polymer comprises a monomer selected from the group consisting of acrylonitrile, methacrylonitrile, acrylates, methacrylates, and combinations thereof; and the third polymer is selected from the group consisting of polyvinylpyrrolidone, polyalkylidene glycol, polyacrylamide, polyethylene glycol, and combinations thereof.

2. The electrode of claim 1, wherein the weight percentage of the first polymer is about 1-90% of the total weight of the binder; the weight percentage of the second polymer is about 1-60% of the total weight of the binder; and the weight percentage of the third polymer is about 0.001-50% of the total weight of the binder.

3. The electrode of claim 1, wherein the fluorine-containing monomer is selected from the group consisting of vinylidene fluoride, fluoroethylene, trifluoroethylene, tetrafluoroethylene, pentafluoroethylene, hexafluoroethylene, and combinations thereof.

4. The electrode of claim 1, wherein the first polymer is selected from the group consisting of polyvinylidene fluoride, polytetrafluoroethylene, polyhexafluoropropylene, a copolymer of vinylidene fluoride and hexafluoropropylene, and combinations thereof.

5. The electrode of claim 1, wherein the first polymer comprises a functional group.

6. The electrode of claim 5, wherein the first polymer has a number average molecular weight in a range of between about 1×10⁴ and about 1×10⁷.

7. The electrode of claim 5, wherein the functional group is selected from the group consisting of unsaturated monocarboxylic acids, unsaturated dicarboxylic acids, mono-alkyl esters of the unsaturated dicarboxylic acids, unsaturated aldehydes, unsaturated ketones, unsaturated monocarboxylic esters, and combinations thereof.

8. The electrode of claim 5, wherein the first polymer comprises a functional group-containing monomer and a fluorine-containing monomer.

9. The electrode of claim 8, wherein the weight ratio of the functional group-containing monomer and the fluorine-containing monomer is in a range of between about 1:10 and about 1:1000.

10. The electrode of claim 1, wherein the second polymer is selected from the group consisting of polyacrylonitrile, polymethacrylonitrile, polyacrylate, polymethacrylate, and combinations thereof.

11. The electrode of claim 10, wherein the second polymer has a number average molecular weight in a range of between about 1×10³ and about 1×10⁶.

12. The electrode of claim 1, wherein the third polymer is selected from the group consisting of polyvinylpyrrolidone, polyglycol, and combinations thereof.

13. The electrode of claim 1, wherein the third polymer has a number average molecular weight in a range of between about 500 and about 1×10⁷.

14. The electrode of claim 1, wherein the weight ratio of the silicon negative active material and the binder is in a range of between about 100:8 and about 100:12.5.

15. The electrode of claim 1, wherein the negative electrode material further comprises a conductive agent.

16. The electrode of claim 15, wherein the conductive agent is selected from the group consisting of graphite, carbon black, acetylene black, colloidal carbon, carbon fiber, and combinations thereof.

17. The electrode of claim 16, wherein the weight ratio of the silicon negative active material and the conductive agent is in a range of between about 100:0.01 and about 100:5.

18. The electrode of claim 1, wherein the silicon negative active material comprises a metal material and a silicon material.

19. A method for preparing a negative electrode comprising:
coating a negative electrode material onto a negative current collector;
wherein the negative electrode material comprises a silicon negative active material and a binder;
wherein the binder comprises a first polymer, a second polymer, and a third polymer;
wherein the first polymer comprises a fluorine-containing monomer; the second polymer comprises a monomer selected from the group consisting of acrylonitrile, methacrylonitrile, acrylates, methacrylates, and combinations thereof; and the third polymer is selected from the group consisting of polyvinylpyrrolidone, polyalkylidene glycol, polyacrylamide, polyethylene glycol, and combinations thereof.

20. A lithium battery comprising:
a negative electrode;
a positive electrode;
a non-aqueous electrolyte in contact with the negative electrode and the positive electrode;
a separator disposed between the negative electrode and the positive electrode; and
a shell;
wherein the negative electrode, the positive electrode, the separator, and the electrolyte are disposed in the shell; and the shell is sealed;
wherein the negative electrode comprises a current collector coated with a silicon negative electrode material;
wherein the silicon negative electrode material comprises a silicon negative active material and a binder;
wherein the binder comprises a first polymer, a second polymer, and a third polymer;
wherein the first polymer comprises a fluorine-containing monomer; the second polymer comprises a monomer selected from the group consisting of acrylonitrile, methacrylonitrile, acrylates, methacrylates, and combinations thereof; and the third polymer is selected from the group consisting of polyvinylpyrrolidone, polyalkylidene glycol, polyacrylamide, polyethylene glycol, and combinations thereof.
